(19) United States
(12) Patent Application Publication
(10) Pub. No.: US 2009/0151407 A1
(43) Pub. Date: Jun. 18, 2009

(54) DOOR LOCK WITH AUTOMATIC LOCKING OF DEADBOLT

(76) Inventor: San Lin, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/955,631

(22) Filed: Dec. 13, 2007

(51) Int. Cl. E05B 63/14

(52) U.S. Cl. 70/107

(57) ABSTRACT

A door lock includes a case mounted in a door and an inside handle mounted to an inner side of the door. A latch bolt is operably connected to the inside handle and movable between an extended, latching position and a retracted, unlatching position. A spring device is mounted to a deadbolt for biasing the deadbolt from a retracted, unlocking position toward an extended, locking position. A positioning member engages with and retains the deadbolt when the deadbolt is in the retracted position. An auxiliary bolt is operably connected to the positioning member and movable between an extended position and a retracted position. The auxiliary bolt disengages the positioning member from the deadbolt when the auxiliary bolt is in the retracted position such that the deadbolt is moved to the extended position by the spring device.

### BACKGROUND OF THE INVENTION

The present invention relates to a door lock and, more particularly, to a door lock including a deadbolt that is automatically moved to a locking position when a door to which the door lock is mounted is moved from an open position to a closed position.

A typical mortise lock includes a deadbolt and a latch bolt for locking a door to which the lock is mounted. The deadbolt is generally moved to its retracted position by a thumb turn mounted to an inner side of the door or by a key. Although the deadbolt provides enhanced burglarproof effect, it must be operated by the key to move to its extended, locking position from the outer side of the door.

A need exists for a door lock with a deadbolt that be automatically moved to its locking position without using the key when the door is moved to the closed position.

### BRIEF SUMMARY OF THE INVENTION

The present invention solves this need and other problems in the field of mortise locks by providing, in a preferred form, a door lock including a case adapted to be mounted in a door and an inside handle adapted to be mounted to an inner side of the door. A latch bolt is mounted in the case and movable between an extended, latching position outside the case and a retracted, unlatching position inside the case. The latch bolt is operably connected to the inside handle such that rotation of the inside handle causes the latch bolt to move from the extended, latching position to the retracted, unlatching position. A deadbolt is mounted in the case and includes an outer end movable between an extended, locking position outside the case and a retracted, unlocking position in the case. A spring device is mounted to an inner end of the deadbolt for biasing the outer end of the deadbolt toward the extended, locking position. Also mounted in the case is a positioning member that engages with and retains the deadbolt in place when the outer end of the deadbolt is in the retracted, unlocking position. An auxiliary bolt is mounted in the case and operably connected to the positioning member. The auxiliary bolt includes a head movable between an extended position and a retracted position. When the door is moved from an open position to a closed position, the auxiliary bolt is moved to its retracted position to disengage the positioning member from the deadbolt such that he deadbolt is moved to the extended, locking position by the spring device. Thus, the deadbolt is automatically moved to the extended, locking position when the door is closed.

In the most preferred form, the spring device includes a spring seat mounted in the case, a guide rod extending from the spring seat and slideably received in a receptacle in the deadbolt, and a spring mounted around the guide rod and between the spring seat and the inner end of the deadbolt. The spring is compressed when the deadbolt is in the retracted, unlocking position. A pivotal member is pivotably mounted in the case and includes an actuating portion. A connecting plate extends from the deadbolt and includes a slot and a notch. The actuating portion of the pivotal member is engaged in the slot of the connecting plate such that pivotal movement of the pivotal member causes movement of the deadbolt between the retracted, unlocking position and the extended, locking position. A thumb turn is pivotably mounted to the case and coupled with the pivotal member to turn therewith. The thumb turn can be manually operated to cause pivotal movement of the pivotal member. The positioning member further includes an end engaged in the notch of the connecting plate when the deadbolt is in the retracted, unlocking position, preventing movement of the deadbolt. A linking member is operably connected to the inside handle. A rocker arm includes a first end pivotably mounted to the case, a second end coupled with the pivotal member, and an intermediate portion between the first and second ends of the rocker arm and coupled with the linking member. When the inside handle is rotated, the linking member and the rocker arm are moved to pivot the pivotal member to retract the deadbolt to the retracted, unlocking position. Specifically, rotation of the inside handle retracts the deadbolt and the latch bolt at the same time. A striker plate is mounted to a jamb of the door and includes a recessed portion. The auxiliary bolt moves outward from the extended position into the recessed portion of the striker plate when the door is in a closed position. In this case, the positioning member is disengaged from the auxiliary bolt that is engaged in the recessed portion. A torsion spring is provided for returning the end of the positioning member to a position for engaging with the notch of the deadbolt when the deadbolt is in the retracted, unlocking position. The torsion spring includes a first tang fixed to the case and a second tang fixed to the positioning member.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a diagrammatic exploded perspective view of a door lock according to the preferred teachings of the present invention.

FIG. 2 shows an elevational view of the door lock of FIG. 1 with a lid of the door lock removed.

FIG. 3 shows an elevational sectional view of the door lock of FIG. 1 with the lid removed and with a latch bolt unlatched by a key.

FIG. 4 shows an elevational view of the door lock of FIG. 1 with the lid removed and with an auxiliary bolt retracted to release a deadbolt.

FIG. 5 shows an elevational view of the door lock of FIG. 1 with the lid removed and with both the auxiliary deadbolt and the deadbolt in extended positions.

FIG. 6 shows a cross sectional view of the door lock of FIG. 1 and a door to which the door lock of FIG. 1 is mounted, with the door is being closed.

FIG. 7 shows a cross sectional view of the door and door lock of FIG. 6 with the auxiliary bolt in contact with a striker plate mounted to a jamb.

FIG. 8 shows a cross sectional view of the door and the door lock of FIG. 6 with the auxiliary bolt received and retained in a retaining groove of the striker plate.

All figures are drawn for ease of explanation of the basic teachings of the present invention only; the extensions of the Figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “end”, “portion”, “section”, “lateral”, “inner”, “outer”, “outward”, “inward”, “clockwise”, “counterclockwise”, and similar terms are used herein, it should be understood that these terms have reference only to the structure shown in the drawings as it would appear to a person viewing the drawings and are utilized only to facilitate describing the invention.

### DETAILED DESCRIPTION OF TEE INVENTION

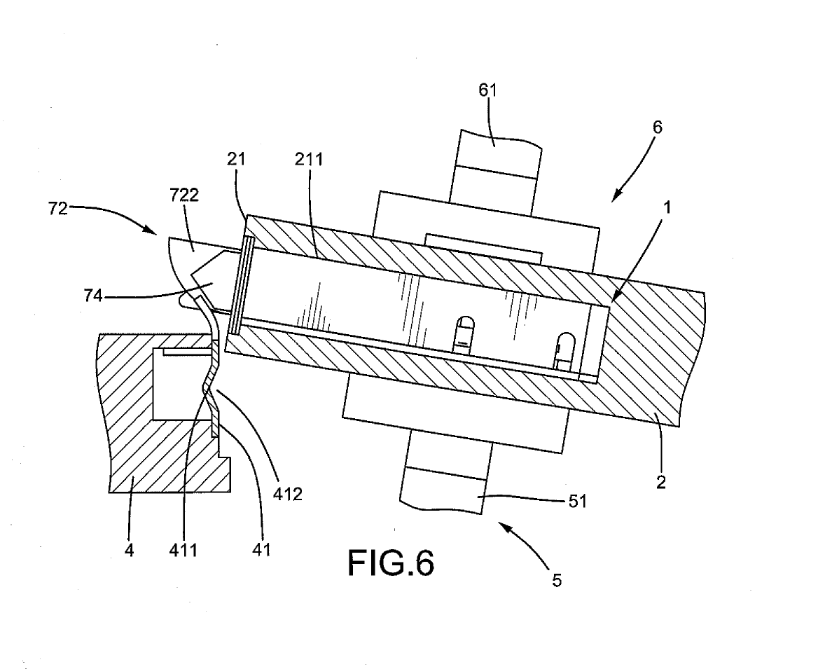

A door lock according to the preferred teachings of the present invention is shown in the drawings and generally designated 1. The door lock 1 is mounted in a compartment 211 in an edge 21 of a door 2 (FIG. 6). The door lock 1 can be fixed to the edge 21 by one or more faceplates 3. A striker plate 41 is mounted to a door jamb 4 facing the edge 21 of the door 2 in a closed position. The striker plate 41 includes a recessed portion 411 having a retaining groove 412.

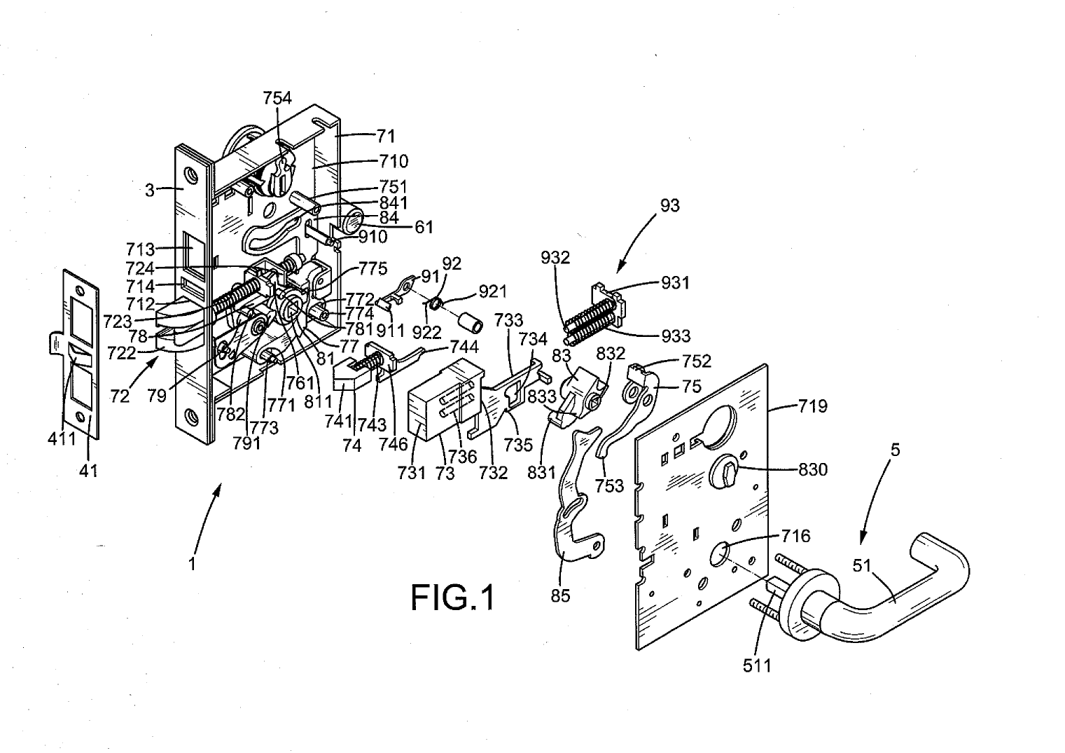

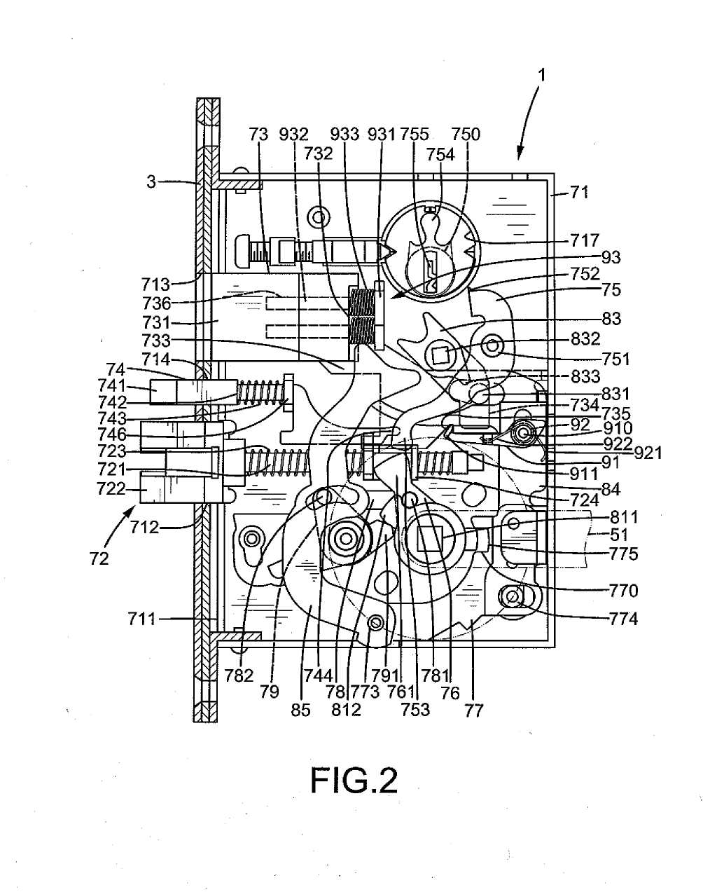

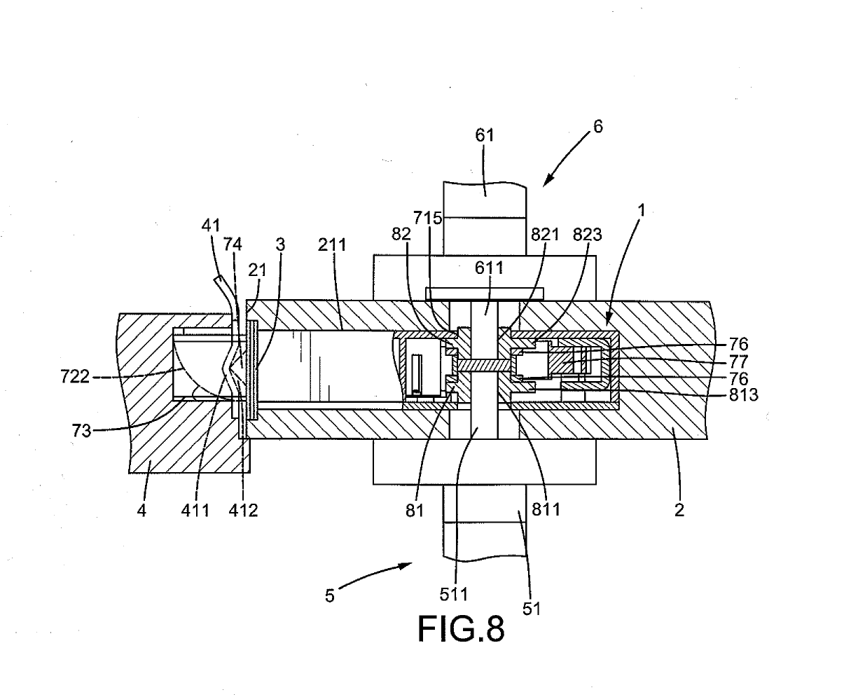

According to the preferred form shown, the door lock 1 includes a substantially parallelepiped case 71 receiving a latch bolt 72, a deadbolt 73, and an auxiliary bolt 74. An inside handle assembly 5 is mounted to an inner side of the door 2 and includes an inside handle 51 and an inside spindle 511 coupled with the inside handle 51 to turn therewith. An outside handle assembly 6 is mounted to an outer side of the door 2 and includes an outside handle 61 and an outside spindle 611 coupled with the outside handle 61 to turn therewith (FIG. 8). The case 71 includes an outer end face 711 to which two faceplates 3 are attached. The case 71 further includes a hole 715 (FIG. 8) in a lateral side 710 (FIG. 1) thereof. A pivot 751 is formed on an inner face of the lateral side 710. The faceplates 3 can be deemed as a part of the case 71. Three openings 712, 713, and 714 extend through the outer end face 711 and the faceplates 3. The case 71 includes an open side to which a lid 719 is mounted. The lid 719 includes a hole 716 aligned with the hole 715 of the lateral side 710. A wheel 81 is pivotably mounted in the hole 716 of the lid 719 and includes a square through-hole 811 through which the inside spindle 511 extends. Another wheel 82 is pivotably mounted in the hole 715 of the lid 710 and includes a square through-hole 821 through which the outside spindle 611 extends. Turning of either handle 51, 61 causes pivotal movement of the associated wheel 81, 82. Each wheel 81, 82 further includes a tooth 812, 822. The wheel 82 further includes a protrusion 823 (FIG. 8). A lock core 750 (FIG. 2) is mounted in a hole 717 in the lateral side 710 of the case 71 and includes an actuating member 754 and a keyway 755.

According to the preferred form shown, the latch bolt 72 includes a head 722 and a shank 721 extending from the head 722 through the opening 712 into the case 71. The head 722 of the latch bolt 72 includes triangular cross sections and is normally biased by a spring 723 to an extended, latching position outside the case 71. A substantially U-shaped bracket 724 is mounted on the shank 721 and drivable by a lever link 75 or one of two drive members 76 to move the latch bolt 72 between the extended, latching position and a retracted, unlatching position in the case 71. The lever link 75 is mounted in the case 71 and includes an intermediate portion pivotably mounted around the pivot 751, a first end 752, and a second end 753 engaged with the bracket 724 of the latch bolt 72. Furthermore, the lever link 75 can be driven by the actuating member 754 of the lock core 750. Specifically, when a key is inserted into the keyway 755 of the lock core 750 and turned, the actuating member 754 is rotated counterclockwise to move the latch bolt 72 inward to its retracted, unlatching position.

Each drive member 76 is mounted to a side of one of the wheels 81, 82 and includes a lug 761 for pushing the bracket 724 of the latch bolt 72. A linking member 78 is also mounted in the case 71 and includes a first pin 781 on an end thereof and a second pin 782 on the other end thereof. The first pin 781 extends through the lugs 761 of the drive members 76. A cam 79 is rotatably mounted to the lateral side 710 of the case 71 and engaged with the second pin 782. The cam 79 includes a projection 791. When either wheel 81, 82 is turned clockwise through operation of the associated handle 51, 61 (FIG. 2), the tooth 812, 822 of the wheel 81, 82 pushes the first pin 781 clockwise, causing clockwise movement of the lug 761 of one of the drive members 76, which in turn, moves the bracket 724 inward, thereby retracting the latch bolt 72. On the other hand, when either wheel 81, 82 is turned counterclockwise, the tooth 812, 822 of the wheel 81, 82 pushes against the projection 791 of the cam 79, causing rotation of the cam 79. The lug 761 of one of the drive members 76 is moved through transmission by the linking member 78. Thus, the latch bolt 72 is retracted.

Also mounted in the case 71 and located adjacent to the wheel 82 is a slideable locking plug 77 including two slots 771 and 772 in which two pivots 773 and 774 are received. The locking plug 77 further includes a face 770 adjacent to the wheel 82 and having a recess 775. A thumb turn 830 is pivotably mounted to the lid 719 and engaged with an axle 832 of a pivotal member 83 to turn therewith. The pivotal member 83 includes a lobe 833 formed on an outer periphery of the axle 832 and an actuating portion 831 projecting from the lobe 833.

According to the preferred form shown, a follower plate 84 is mounted in the case 71 and connected to the locking plug 77 so that upward/downward movement (as viewed from FIG. 2) of the follower plate 84 causes leftward/rightward movement (as viewed from FIG. 2) of the locking plug 77. The follower plate 84 includes a slot 841 for engaging with the actuating portion 831 of the pivotal member 83. When the pivotal member 83 pivots in response to pivotal movement of the thumb turn 830, the follower plate 84 is moved upward/downward and urges the locking plug 77 to move leftward/rightward. When the locking plug 77 is in its right, locking position, the protrusion 823 on the wheel 82 is engaged in the recess 775 of the locking plug 77 such that the latch bolt 72 can not be retracted, for the outer handle 61 can not be turned.

According to the preferred form shown, a rocker arm 85 is mounted in the case 71 and includes a first end 851 pivotably mounted to the case 71, a second end 852, and an intermediate section having a slot 853 receiving the second pin 782 of the linking member 78. The second end 852 of the rocker arm 85 abuts against the lobe 833 of the pivotal member 83. Thus, when the either handle 51, 61 is turned, the cam 79, the second pin 782 of the linking member 78, and the rocker arm 85 are moved in sequence to thereby pivot the pivotal member 83.

According to the preferred form shown, the deadbolt 73 is in the form of a parallelepiped and includes an outer end 731 extendable through the opening 713 between an extended, locking position outside the case 71 and a retracted, unlocking position in the case 71. The deadbolt 73 further includes an inner end 732 from which a connecting plate 733 extends. The deadbolt 73 further includes two receptacles 736 extending from the inner end 732 toward the outer end 731. The connecting plate 733 includes a slot 734 extending from a first side through a second side thereof and perpendicular to a moving direction of the deadbolt 73. The connecting plate 73 further includes a notch 735 in an underside thereof. The actuating portion 831 of the pivotal member 83 extends through the slot 734 such that the deadbolt 73 can be moved by pivotal movement of the pivotal member 83. A positioning member 91 is pivotably mounted to a peg 910 on the inner face of the lateral side 710 of the case 71. In the most preferred form shown, the positioning member 91 including a front end 911 engaged in the notch 735 to position the deadbolt 73 in the retracted, unlocking position. A torsion spring 92 is mounted to the positioning member 91 for biasing the front end 911 of the positioning member 91 to a position engaged with the notch 735 of the deadbolt 73. The torsion spring 92 includes a first tang 921 attached to an inner face of the case 71 and a second tang 922 attached to the positioning member 91.

According to the preferred form shown, the door lock 1 further includes a spring device 93 mounted to the inner end 732 of the deadbolt 73 for biasing the deadbolt 73 outward to its extended, locking position. In the most preferred form shown, the spring device 93 includes a spring seat 931 fixed in the case 71, two guide rods 932 extending from a side of the spring seat 931 and slideably received in the receptacles 736 of the deadbolt 73, and two springs 933 mounted around the guide rods 932. When the deadbolt 73 is in its retracted, unlocking position, the springs 933 are compressed.

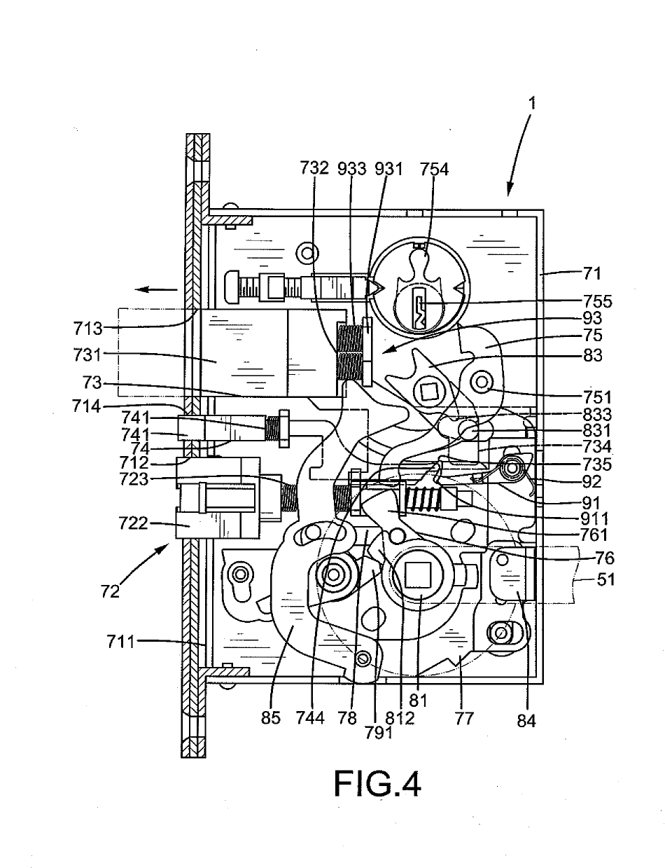

According to the preferred form shown, the auxiliary bolt 74 includes a head 741 and a shank 742 extending from the head 741. In the most preferred form shown, the head 741 of the auxiliary bolt 74 includes two inclined faces meeting at a point. The head 741 of the auxiliary bolt 74 is movable through the opening 714 between an extended, latching position beyond the faceplates 3 and a retracted position in the case 71. The shank 742 is slideably extended through a plate 746 from which a leg 744 extends away from the head 741. A spring 743 is mounted around the shank 742 between the head 741 and the plate 746 to bias the auxiliary bolt 74 toward the extended, latching position. With reference to FIG. 4, when the auxiliary bolt 74 is in its retracted, unlocking position, the leg 744 comes in contact with the front end 911 of the positioning member 91 and urges the front end 911 of the positioning member 91 to disengage from the notch 735 of the deadbolt 73.

Now that the basic construction of the door lock 1 of the preferred teachings of the present invention has been explained, the operation and some of the advantages of the door lock 1 can be set forth and appreciated. With reference to FIGS. 2 and 6, when the door 2 is not closed, the latch bolt 72 and the auxiliary bolt 74 are in their extended, latching positions whereas the deadbolt 73 is in its retracted, unlocking position. It is noted that the front end 911 of the positioning member 91 is engaged in the notch 735 of the deadbolt 73 to retain the deadbolt 73 in the retracted, unlocking position.

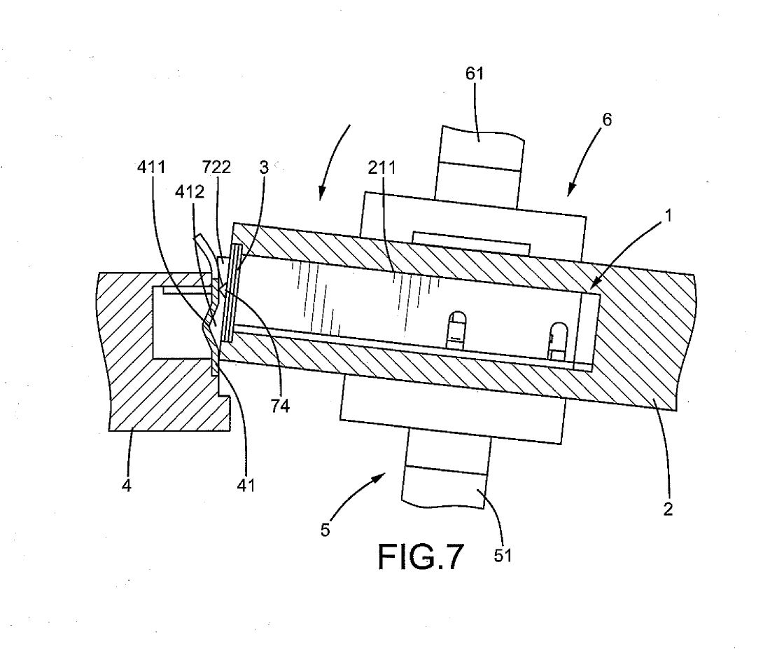

With reference to FIGS. 4 and 7, when the door 2 is being closed, the head 722 of the latch bolt 72 and the outer end 741 of the auxiliary bolt 74 come in contact with the striker plate 41 mounted to the jamb 4 such that the latch bolt 72 and the auxiliary bolt 74 move to their retracted positions. As mentioned above, when the auxiliary bolt 74 is in its retracted position, the leg 744 urges the front end 911 of the positioning member 91 to disengage from the notch 735 of the deadbolt 73. The deadbolt 73 is moved outward to its extended, locking position under the action of the spring device 93.

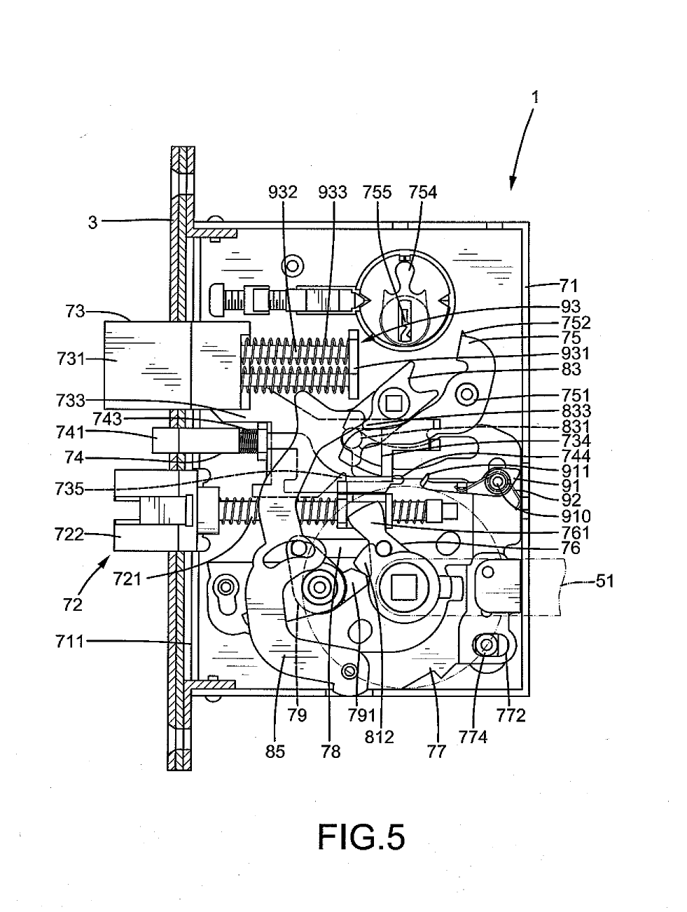

With reference to FIGS. 5 and 8, when the door is completely closed, the latch bolt 72 and the deadbolt 73 are in their extended positions. It can be appreciated that the outer end 741 of the auxiliary bolt 74 is received in the retaining groove 412 of the recessed portion 411 of the striker plate 41 such that the auxiliary bolt 74 is moved further outward to a position disengaged from the positioning member 91. Thus, the front end 911 of the positioning member 91 is pivoted back to its original position under the action of the torsion spring 92. When the door 2 is opened again, the deadbolt 73 is retracted to a position wherein the notch 735 of the deadbolt 73 is reengaged with the front end 911 of the positioning member 91, retaining the deadbolt 73 is retained in its extended, locking position.

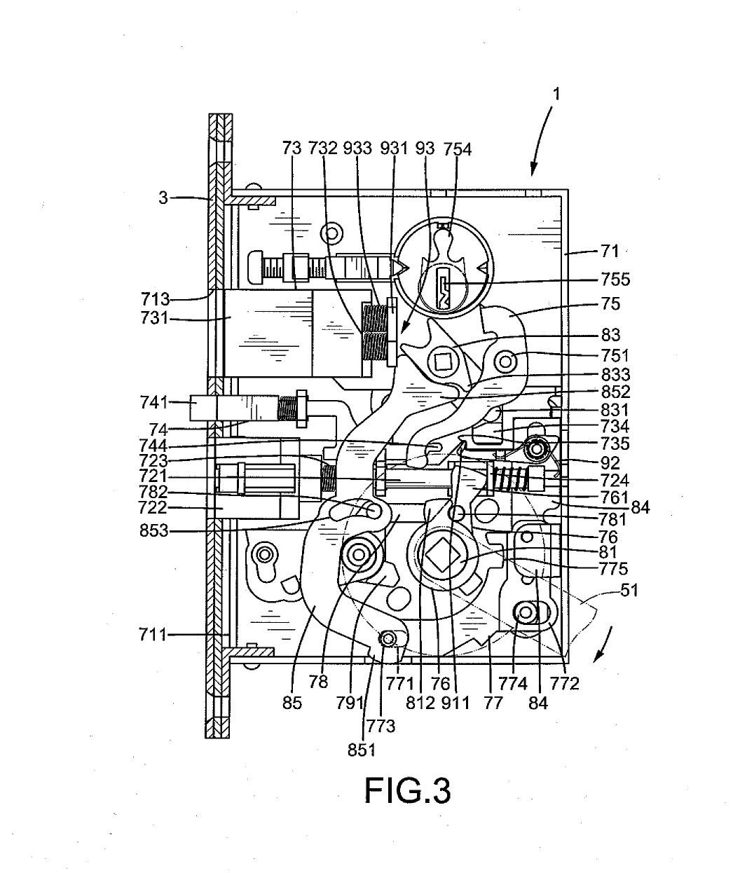

With reference to FIG. 3, in the case that the door 2 is in the closed position, when the inside handle 51 is rotated, one of the drive members 76 is actuated to move the latch bolt 72 inward and causes movement of the linking member 78 and the rocker arm 85. When the rocker arm 85 pivots, the pivotal member 83 is pivoted to retract the deadbolt 73 and to retain the deadbolt 73 in position due to engagement with the positioning member 91. The door lock 1 is, thus, in an unlocked, unlatched state.

When the door 2 is closed, unlocking from the outer side of the door 1 can be attained by inserting a key into the keyway 755 and turning the key to unlock the deadbolt 73 through pivotal movement of the pivotal member 83 by the actuating member 754. Thus, the deadbolt 73 is moved inward to its retracted, unlocking position by the pivotal member 83.

The door lock 1 according to the preferred teachings of the present invention allows auto-locking of the deadbolt 73 when the door 2 is moved from the open position to the closed position without the use of the key from the outer side of the door 2. The deadbolt 73 and the latch bolt 72 are simultaneously unlocked/unlatched when the inside handle 51 is rotated, allowing easy operation.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A door lock comprising:
a case adapted to be mounted in a door;
an inside handle adapted to be mounted to an inner side of the door;
a latch bolt mounted in the case and movable between an extended, latching position outside the case and a retracted, unlatching position inside the case, with the latch bolt being operably connected to the inside handle such that rotation of the inside handle causes the latch bolt to move from the extended, latching position to the retracted, unlatching position;
a deadbolt mounted in the case and including an outer end and an inner end, with the outer end of the deadbolt being movable between an extended, locking position outside the case and a retracted, unlocking position in the case;
a spring device mounted to the inner end of the deadbolt for biasing the outer end of the deadbolt toward the extended, locking position;
a positioning member mounted in the case, with the positioning member being engaged with and retaining the deadbolt in place when the outer end of the deadbolt is in the retracted, unlocking position; and
an auxiliary bolt mounted in the case and including a head movable between an extended position and a retracted position, with the auxiliary bolt being operably connected to the positioning member,
with the auxiliary bolt disengaging the positioning member from the deadbolt when the auxiliary bolt is in the retracted position such that the deadbolt is moved to the extended, locking position by the spring device.

2. The door lock as claimed in claim 1, with the deadbolt including a receptacle, with the spring device including a spring seat mounted in the case, a guide rod extending from the spring seat and slideably received in the receptacle, and a spring mounted around the guide rod and between the spring seat and the inner end of the deadbolt, and with the spring being compressed when the deadbolt is in the retracted, unlocking position.

3. The door lock as claimed in claim 1, further comprising, in combination:
a pivotal member pivotably mounted in the case and including an actuating portion;
a connecting plate extending from the deadbolt and including a slot and a notch, with the actuating portion of the pivotal member being engaged in the slot of the connecting plate such that pivotal movement of the pivotal member causes movement of the deadbolt between the retracted, unlocking position and the extended, locking position; and
a thumb turn pivotably mounted to the case and coupled with the pivotal member to turn therewith, with the thumb turn being adapted to be manually operated to cause pivotal movement of the pivotal member,
with the positioning member further including an end engaged in the notch of the connecting plate when the deadbolt is in the retracted, unlocking position, preventing movement of the deadbolt.

4. The door lock as claimed in claim 3, further comprising, in combination: a torsion spring for returning the end of the positioning member to a position engaged with the notch of the deadbolt, with the torsion spring including a first tang fixed to the case and a second tang fixed to the positioning member.

5. The door lock as claimed in claim 3, further comprising, in combination:
a linking member operably connected to the inside handle; and
a rocker arm including a first end pivotably mounted to the case, a second end coupled with the pivotal member, and an intermediate portion between the first and second ends of the rocker arm and coupled with the linking member,
wherein when the inside handle is rotated, the linking member and the rocker arm are moved to pivot the pivotal member to retract the deadbolt to the retracted, unlocking position.

6. The door lock as claimed in claim 1, further comprising, in combination: a striker plate adapted to be mounted to a jamb of the door, with the striker plate including a recessed portion, with the auxiliary bolt moving outward from the extended position into the recessed portion of the striker plate when the door is in a closed position, with the positioning member being disengaged from the auxiliary bolt that is engaged in the recessed portion, with the door lock further comprising, in combination: a spring for returning the positioning member to a position for engaging with and retaining the deadbolt when the deadbolt is moved to the retracted, unlocking position.
